(19) United States
(12) Patent Application Publication
(10) Pub. No.: US 2006/0179480 A1
(43) Pub. Date: Aug. 10, 2006

(54) Method for interconnecting virtual private networks in non-connected mode

(75) Inventors: Vincent Jardin, Viroflay (FR); Alain Ritoux, Paris (FR)

Correspondence Address: BROWDY AND NEIMARK, P.L.L.C.;624 NINTH STREET, NW, SUITE 300, WASHINGTON, DC, 20001-5303, US

(73) Assignee: 6WIND, Montigny Le Bretonneux (FR)

(21) Appl. No.: 10/546,292

(22) PCT Filed: Dec. 24, 2003
(86) PCT No.: PCT/FR03/03907

§ 371 Date: Aug. 22, 2005

(30) Foreign Application Priority Data
Feb. 20, 2003 (FR) 03/02116

(51) Int. Cl. G06F 15/16

(52) U.S. Cl. 726/15

(57) ABSTRACT

The invention consists in implanting an encapsulation mechanism (ME) in an operator access router, whereby said encapsulation mechanism can calculate a header for messages that the transmitter site (B1) wishes to send to the receiver site (Bn′), said header containing at least one prefix concerning the service provided by the operator, a virtual private network identifier (VPNB), a destination site (Bn′) network prefix and a suffix which consists of a field of bits which can assume any particular value.

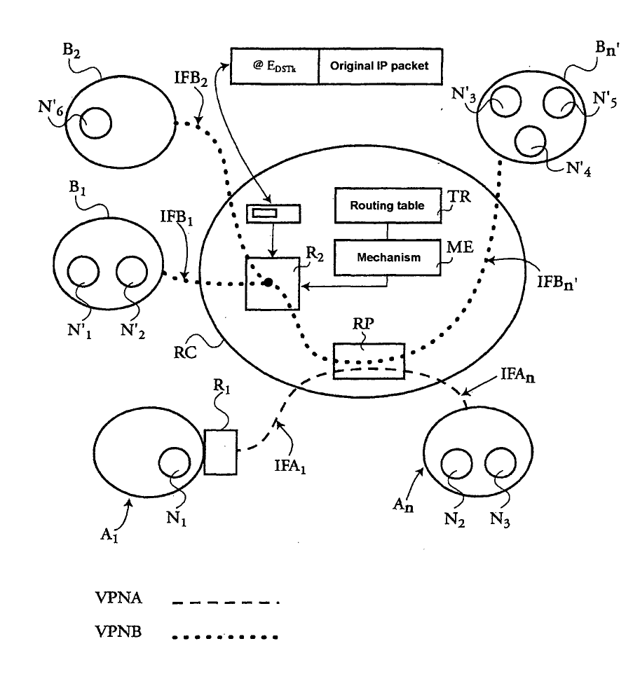

The present invention relates to a method for interconnecting virtual private networks in non-connected mode.

Generally, it is known that the networks of different sites of a same company are interconnected by a service which makes the interconnection system transparent. This type of transparent interconnection of different networks, which use the resources of an operator, is called a virtual private network or VPN.

At the present time, there are mainly two large architectural families of virtual private networks VPNs:
The first of these two architectural families directly connects the customer sites via tunnels (for example, GRE, L2TP, IPsec) beginning and finishing at the customer access router (CPE—Customer Premises Equipment) which, by definition, is the last access router of the customer site which connects it to one or several operators. This method has some flexibility for the customer, and higher security as the customer keeps the control of his/her equipment. However, it may prove to be relatively unwieldy to manage, notably because:
of the large number of tunnels to be managed:

$$\frac{N ( N - 1 )}{2}$$

in the case of a full-mesh type network comprising a number N of customer access routers (CPE),
of the number and the distance of the network equipment to be configured for the customer access routers (CPE), which may involve travel of a technician in the case of a bad configuration.
The solution suggested in the second architectural family consists of establishing links from virtual private networks (VPN), not customer access routers (CPE), to customer access routers, but from operator access routers (PE—Premises Equipment) to operator access routers (PE). For this, the most commonly used solution consists of using in the core network, the technology of label switching networks (MPLS—Multi Protocol Label Switching) which is a network technology of the connected mode type, with which circuits may be established, and the forwarding mode of which is based on switching from one to the next depending on the label. In this case, the operator access routers (PE) establish a grid consisting of LSP (Label Switch Path) paths which consist in kinds of tunnels of label switching networks (MPLS). Regarding this matter, let us recall that, by definition, systems are interconnected in a connecting mode when there is a state of the link. Thus, a label switching network (MPLS) requires opening of a path in the core of the network (Core Network) between the end routers (MPLS).
It is seen that this second architectural family requires many more resources on the access router (PE—Premises Equipment) of the operator which forms the first edge router of an operator to which the IP frames of a customer are forwarded. However, it has lower management costs because:
   the operator access routers (PE) are much less numerous than the customer access routers (CPE),
   the operator access routers are usually managed in a centralized way at the ISP (Internet Service Provider).

However, the main drawbacks of this second solution result from the fact that:
It is not a native solution of the IP Internet protocol, so that adding an extra protocol increases the complexity of the system.
The technology (MPLS) is not available in all the networks.
It is not possible to globally use the technology (MPLS) on different administrative network entities.

More particularly, the object of the invention is therefore to eliminate these drawbacks.

For this purpose, a method based on a format of the network addresses is proposed, which provides automatic encapsulation of the data in order to forward them between IP private networks, in order to obtain a simple and automated solution to the problems of virtual private networks VPNs, both on the customer access routers (CPE) and on the operator access routers (PE). According to the invention, this method consists of setting up in the access router (CPE or PE) a simple encapsulation mechanism allowing a header to be calculated of the messages which a transmitter site Aᵢ wishes to send to a receiver site Aⱼ, this header comprising at least one PREF_{service} prefix concerning the service provided by the operator, a virtual private network (VPN) identifier, a network prefix Nⱼ of the receiver site Aⱼ and a suffix Sx which consists of a field of bits which may assume any value.

Advantageously, the method may use IPv6 type addressing according to which the addresses are coded on 128 bits. In this case, the following advantages may be obtained:
The method according to the invention does not involve a migration to IPv6 networks from the existing IPv4 private networks. Consequently, the users may continue to use their IPv4 infrastructure and their private addressing scheme transparently.
This method does not involve for the operator any updating of all the routers of its core network as this is the case for label switching techniques (MPLS).
The interconnections between the IPv6 networks of the operators may be performed by IPv6/IPv4 migration tunnels.
This method is able to provide network traffic engineering services comparable to the services of current label switching virtual private (VPN-MPLS) networks by only using the QoS (Quality of Service) mechanisms already existing in IPv6 networks (for example with the FlowLabel field of the IPv6 headers).

As regards solutions of the MPLS type, the advantages of the solution according to the invention are the following:
The IP packet flux may be forwarded in the non-connected mode by the core network. Accordingly, the interconnection service via the VPN virtual private network is less expensive to lay out. The automatic operation obtained by the method according to the invention, is an appreciable advantage.
For the same reason, the IP packet flux may also be forwarded beyond an operator administrative management entity (standalone system) while being confined to certain standalone systems by suitable routing policy rules (eBGP).
It is possible to select two forwarding modes, one of which allows the number of prefixes which are announced, to be aggregated.
There is a plurality of modes for applying the method according to the invention, the selection of which depends on the different available routing protocols. In any case, these application modes use the semantics of the previously defined address format.
When the core network provides support for multicast multi-hop addressing, the latter may be used for propagating information from the pairs (private network, router for accessing this private network) between the end routers of the virtual private network VPN, without loading an internal switching table.
When multicast routing support does not exist, it is possible to use unicast routing tables with which the forwarding service may continue to be provided between the private networks.
By means of technologies relying on IP security (<<IPsec>>), security of these non-connected VPN virtual private networks may be more reliably contemplated by using encryption and authentication.

The QoS (Quality of Service) services existing in IP architectures may be reused without any change. This is an alternative to traffic engineering of label switching networks for the network cores.

Embodiments of the invention will be described hereafter, as non-limiting examples, with reference to the appended drawing wherein:

The unique FIGURE is a diagram of a network environment related to the method according to the invention.

More specifically, the unique FIGURE shows two virtual networks VPN_{A}, VPN_{B}, in dashed and dotted lines, respectively, comprising n, n′ sites, respectively, i.e.: A₁ . . . Aₙ, B₁ . . . Bₙ, as well as m, m′ local networks N₁ . . . Nₘ, N′₁ . . . N′_{m′} respectively, each having consistent addressing. These local networks are connected to p routers R₁ . . . Rₚ of the PE or CPE type, via n interfaces IF_{A1} . . . IF_{An} and n′ interfaces IF_{B1}, IF_{B2} . . . IF_{Bn′}. Interfaces IF_{A1} and IF_{An} are the interfaces of sites A₁ and Aₙ, respectively, whereas the interfaces IF_{B1}, IF_{B2}, IF_{Bn′} are the interfaces of sites B₁, B₂, B_{n′}, respectively. These interfaces may be virtual or physical. Several interfaces (IF_{A1} . . . IF_{An}-IF_{B1}, IF_{B2} . . . IF_{Bn′}) may be on a same router. Also, several sites may be connected to a same router: routers R₁ . . . Rₚ comprise the two stacks of IPv4 and IPv6 Internet protocols.

In the context of the method according to the invention, it is a matter of using a transmission according to the IPv6 protocol between the interfaces IF_{A1} . . . IF_{An} of the routers R₁ . . . Rₚ in order to transport the data of the virtual private network VPN_{A} between the sites A₁, . . . Aₙ, it being understood that in order to meet scale (scalability) and simplicity criteria, this transmission should use neither static connected tunnels, nor dynamic connected tunnels, as this will be the case in a label switching (MPLS).

In fact, the problem which the invention aims to solve may be stated as follows: If one designates by Nᵢ (1≦i≦m) a network prefix of a site Aₖ (1≦k≦n) to which the site Aⱼ (1≦j≦n) wishes to send messages as IP packets, one of the tasks that the method according to the invention will have to perform, is having the network determine the way according to which an IP packet which arrives on the interface IF_{Aj} may be transmitted to the interface IF_{Ak}.

The solution that the invention proposes for solving this problem consists of building the destination address IF_{Ak} from the prefix of the PREF_{service} service provided by the operator, from the identifier of the VPN virtual private network and from the network prefix Nᵢ of the destination site Aₖ. This address which is then used for solving the forwarding problems appears in the following form:
Address of IF_{Ak}=PREF_{service}:PREF_{feed}:VPN_{A}:Nᵢ::SX/(M+M_{f}+M_{VPN}+Mᵢ)

Expression wherein:

PREF_{service}/M is the network prefix used for the service provided by the operator,

Nᵢ/Mᵢ is one of the (IPv4 or IPv6) prefixes of the destination site Aₖ which may be reached via the destination interface IF_{Ak}

VPN_{A} is the identifier of the common virtual private network to which belong sites Aⱼ and Aₖ, VPN_{A} being coded on M_{VPN} bits

PREF_{feed}/M_{f} is a constant field of bits, with which the length of the address may be adjusted,

Sx is a field of bits which may assume any value and which is the suffix of the address.

The unique figure specifies the location where the mechanism is involved in the architecture. It shows the progress of the IP packets in the network and reveals the change provided by the ME mechanism concerning the header (by taking the VPN_{B} as an example here).

This ME mechanism for interconnecting virtual private networks is set up in an access router of the operator (PE) located on the edge of the core network (RC), the router R₂, here. This ME mechanism provides encapsulation of the PA packets and assigns a new header to the thereby encapsulated packets. These PA packets may then be decapsulated by the access router of the operator (PE), Rₚ here, or by the access router of the customer (CPE) associated with the destination network, B_{n′}, here.

In this example, the local network B₁ which desires to send messages to the destination local network B_{n′} uses an access router R₂, at the edge of the core network RC for encapsulating the packets. This encapsulation is carried out by an interconnection mechanism using a routing table TR with which it is possible to determine through which nodes the IP packets pass within the core network RC.

With this mechanism, it is possible to associate with the original IP packet a new header comprising the address of the interface IF_{Bn′} of the site B_{n′} (@E_{DSTk}) here, to which the transmitter site B₁ wishes to send IP packets.

Examples I-VII illustrate the principle for determining a IF_{Ak} address when an IPv4 type infrastructure is used:

### EXAMPLE I

The items entering into the construction of the address of the IF_{Ak} interface are the following:
PREF_{service}/M=2001:baba:1234::/48 (operator service network prefix)
PREF_{feed}/M_{f}=0/0
VPN_{A}/M_{VPN}=6100/16 (common virtual private network identifier)
Nᵢ/Mᵢ=10.10.1.0/23(0a.0a:01.00/23) (prefix of site Aₖ)

According to the invention, the IF_{Ak} address is determined by expression (1) and is expressed as:
IF_{Ak}=2001:baba:1234:6100:0a0a:0100::/87

### EXAMPLE II

In this example, the items PREF_{service}/M, PREF_{feed}/M_{f}, VPN_{A}/M_{VPN} and Nᵢ/Mᵢ are expressed as:
PREF_{service}/M=2001:baba:1234::/48
PREF_{feed}/M_{f}=0506:0708/32(=128-48-32-16)
VPN_{A}/M_{VPN}=6100/16
Nᵢ/Mᵢ=10.10.1.0/23(0a.0a.01.00/23)

The expression of IF_{Ak} is then the following:
IF_{Ak}=2001:baba:1234:0506:0708:6100:0a0a:0100::/119

In the worst case, with item PREF_{feed}, it is possible to have a 128 bit IF_{Ak} address, for example.

### EXAMPLE III

This example relates to determining the IF_{Ak} address, in the case of an IPv6 type infrastructure. The following items are involved:
PREF_{service}/M=2001:baba:1234::/48
PREF_{feed}/M_{f}=0/0
VPN_{A}/M_{VPN}=6100/16
Nᵢ/Mᵢ=fec0:cafe:deca:clc0::/64

From this, it is inferred that:
IF_{Ak}=2001:baba:1234:06100:fec0:cafe

Of course, the sum M+M_{f}+M_{VPN}+Mᵢ should in any case be less than or equal to 128 bits.

### EXAMPLE IV

This example relates to applying the invention to 4in6 or 6in6 type encapsulation.

This type of encapsulation consists of transporting an IPv4 packet (the case of a 4in6 encapsulation) or an IPv6 packet (the case of a 6in6 encapsulation) inside an IPv6 packet.

The Nₕ network E_{SRCj} source and Nᵢ network E_{DSTk} destination encapsulation addresses are built in the following way:
E_{SRCj}=PREF_{service}:PREF_{feed}:VPN_{A}:Nₕ::Sx
E_{DSTk}=PREF_{service}:PREF_{feed}:VPN_{A}:Nᵢ::Sx

Expressions wherein:
PREF_{service}/M is the network prefix used by the service provided by the operator
Nₕ and Nᵢ are the source and destination addresses (the complete address in IPv4, or only the first 64 bits in IPv6) of a flux between two terminals of sites Aⱼ and Aₖ
VPN_{A} is the identifier of the common virtual private network to which belong sites Aⱼ and Aₖ, which is on M_{VPN} bits. Addresses E_{SRCj} and E_{DSTk} can only exist if the sum: M+M_{f}+M_{VPN}+length (Nₓ) is less than or equal to 128 bits (x=h or i).

### EXAMPLE V

This example relates to the transmission of an IPv4 frame from a 10.10.2.0/24 IPv4 private network with a source address 10.10.2.1, which should be forwarded to an IPv4 terminal with address 10.10.1.1 of the 10.10.1.0/24 network with:
PREF_{service}/M=2001:baba:1234::/48
PREF_{feed}/M_{f}=0/0
VPN_{A}/M_{VPN}=6100/16
Nₕ=10.10.2.1(0a.0a.02.01)
Nᵢ=10.10.1.1(0a.0a.01.01)

The encapsulation addresses are then:
E_{SRCj}=2001:baba:1234:6100:0a0a:0201::
E_{DSTk}=2001:baba:1234:6100:0a0a:0101::

### EXAMPLE VI

This example relates to a transmission of the type of the one of Example V but in which PREF_{feed} is used in the worst case with:
PREF_{service}/M=2001:baba:1234::/48
PREF_{feed}/M_{f}=0506:0708/32(=128-48-32-16)
VPN_{A}/M_{VPN}=6100/16
Nₕ=10.10.2.1(0a.0a.02.01)
Nᵢ=10.10.1.1(0a.0a.01.01)

The following encapsulation addresses are obtained:
E_{SRCj}=2001:baba:1234:0506:0708:6100:0a0a:0201
E_{DSTk}=2001:baba:1234:0506:0708:6100:0a0a:0101

### EXAMPLE VII

This example relates to a transmission analogous to the one of Example V in the case of an IPv6 type VPN virtual private network.

In this case, it is sufficient to keep the first 64 bits of Nₕ and Nᵢ which are significant and describe the IPv6 networks.

Here, the transmission of an IPv6 frame from a fec0:cafe:deca:c2c0::/64 IPv6 private network with a source address fec0:cafe:deca:c2c0::EUI64, which should be forwarded to the IPv6 terminal with address fec0:cafe:deca:clc0::EUI64 of the fec0:cafe:deca:clc0::/64 network:

The encapsulation addresses are then expressed as:
E_{SRCj}=2001:baba:1234:6100:fec0:cafe:deca:c2c0
E_{DSTk}=2001:baba:1234:6100:fec0:cafe:deca:clc0.

The forwarding of data towards their destination poses a problem which depends on the number of virtual private networks to be served. It involves building a routing table which may use the existing routing of the operator or a routing protocol with multi-hop type distribution, it being understood that the first solution which uses the routing of the operator does not allow any aggregation, whereas the second solution mentions an aggregation solution.

Examples VIII and IX hereafter illustrate both of these types of solutions:

### EXAMPLE VIII

### Use of the Existing Routing of the Operator

If the prefix of the IF_{Ak} interface of the router Rₖ is redistributed by a standard routing protocol (for example of the BGP, OSPFv3, RIPng type), then the frames which have a destination address E_{DSTk}, which is comprised in this prefix, are naturally forwarded towards the IF_{Ak} interface.

For an operator who provides a number N of virtual private networks VPNs and the largest virtual private network VPN of which has M sites, then the forwarding tables all have about N times M extra routes. This solution proves to be acceptable as long as the product N·M is much smaller than an IPv4 routing table (i.e. 120,000 entries) with a growth of about 20 entries per year.

For example, if the operator provides a service of 10,000 virtual private networks of 12 sites, then his/her v6 internal routing table will be loaded as much as the IPv4 table.

With this method, it is therefore possible to obtain a single encapsulation level.

### EXAMPLE IX

This solution uses a multi-hop distribution routing protocol corresponding to a modified RIPng or OSPFv3 routing protocol version for supporting multicast broadcasting beyond several nodes. They may also consist of proprietary protocols or of the protocol named MP-BGP4.

At the level of the router Rⱼ, the problem is equivalent to discovering the addresses of the IF_{Ak} interfaces of the router Rₖ in order to transmit the useful load to it. Therefore, if an IPv6 routing protocol of the multi-hop multicast or unicast full-mesh type is used, it is sufficient to replace the next hop with the global address of the router Rₖ. Thus, reachability between IF_{Aj} and IF_{Ak} of the same VPN_{A} virtual private network without loading the forwarding tables of the internal routers is extended in the non-connected mode.

This method therefore has two encapsulation levels.

However if IPv6 header options such as Destination Option are used, only one encapsulation level is required.

An important advantage of the mechanism applied by the method according to the invention, consists in that it may be used for more easily laying out a virtual private network (VPN) service which is provided by the operator. Further, it allows such virtual networks (provided by the operator) to be laid out between several operators for a same virtual private network VPN.

An another advantage provided by the invention consists in that it may be used in laying out solutions for aggregating IPv4 and IPv6 addressing schemes and in that it avoids the operators having to broadcast prefixes of the IF_{Ak} interfaces over all the Internet network.

This solution is particularly well suited for providing an IP type alternative to label switching networks (MPLS).

1. A method for interconnecting virtual private networks in non-connected mode, so as to provide transmission of messages between interfaces of routers in order to transport data between a transmitter site and a receiver site, via an access router of an operator, said method consisting of setting up in this router or via a customer access router an encapsulation mechanism suited to calculate a header for the messages that the transmitter site wishes to send to the receiver site, this header comprising at least one prefix relating to the service provided by the operator, a virtual private network identifier, a network prefix of the destination site, and a suffix which consists of a field of bits which may assume any value.

2. The method according to claim 1, using IPv6 type addressing wherein the addresses are coded on 128 bits.

3. The method according to claim 1, wherein the interconnections between the networks of the operators are carried out by migration tunnels.

4. The method according to claim 2, using service quality mechanisms already existing in the networks in order to provide network traffic engineering services analogous to those of label switching virtual private networks.

5. The method according to claim 1, wherein the packet flow is forwarded in the non-connected mode by a core network.

6. The method according to claim 1, using multicast multi-hop type routing for propagating information from private network/access router pairs to this private network between the end routers of the virtual private network, without loading an internal switching table, when the core network provides support for routing of this type.

7. The method according to claim 1, using unicast type routing tables for providing the forwarding service between the private networks, in the absence of multicast type routing support.

8. The method according to claim 1, comprising encryption and authentication of the messages for making the non-connected virtual private networks secure by means of technologies relying on security.

9. The method according to claim 1, wherein said encapsulation mechanism is laid out in an access router of the operator or in a customer access router located at the edge of the core network, and in that the packets encapsulated by this mechanism are decapsulated by the access router of the operator or by the customer access router associated with the destination network.

10. The method according to claim 1, wherein encapsulation mechanism uses a routing table which determines the nodes through which the packets should pass inside the core network.

11. The method according to claim 1, wherein, to solve the problems for forwarding the packets, the aforesaid mechanism builds destination addresses appearing in the following form:
Address of IF_{Ak}=PREF_{service}:PREF_{feed}:VPN_{A}:Nᵢ::Sx/(M+M_{f}+M_{VPN}+Mᵢ)
Expression wherein:
PREF_{service}/M is the network prefix used for the service provided by the operator
Nᵢ/Mᵢ is one of the (IPv4 or IPv6) prefixes of the destination site (Aₖ) which is reachable by the destination interface (IF_{Ak})
VPN_{A} is the identifier of the common virtual private network to which belong sites Aⱼ and Aₖ, VPN_{A} being coded on M_{VPN} bits PREF_{feed}/M_{f} is a constant field of bits with which the length of the address may be adjusted
Sx is a field of bits which may assume any value and which is a suffix of the address.
